(19) United States
(12) Patent Application Publication
(10) Pub. No.: US 2004/0230781 A1
(43) Pub. Date: Nov. 18, 2004

(54) Method and system for predicting the execution of conditional instructions in a processor

(75) Inventors: Charles F. Shelor, Arlington, TX (US); Richard L. Duncan, Bedford, TX (US)

Correspondence Address: DUANE MORRIS, LLP, IP DEPARTMENT, ONE LIBERTY PLACE, PHILADELPHIA, PA, 19103-7396, US

(73) Assignee: VIA-Cyrix, Inc., Fremont, CA

(21) Appl. No.: 10/439,941

(22) Filed: May 16, 2003

(51) Int. Cl. G06F 9/00

(52) U.S. Cl. 712/239

(57) ABSTRACT

A method and system is disclosed for predicting whether a conditional instruction is to be executed in a processor. The processor processes instructions through processing stages including at least a decode stage, an execute stage, and one or more intermediate processing stages therebetween. First, a current condition status of the processor is detected, wherein the condition status shows whether one or more conditions for executing the conditional instruction have been satisfied. After detecting whether one or more associated instructions as being processed during the intermediate processing stages have impacted or will impact the conditions to be satisfied, it is determined whether the conditional instruction should be terminated at the decode stage based on the detected current condition status and the detected impact on the conditions due to the processing of the associated instructions. If it is predicted that there are unsatisfied conditions for executing the conditional instruction in the execute stage, the conditional instruction is terminated in the decode stage so as to avoid utilizing additional processor resources.

### BACKGROUND

The present invention relates generally to computers, and more specifically to predicting the possibility of executing certain instructions whose executions depend on certain prerequisite conditions to be satisfied.

As it is known, a processor executes an individual instruction in a sequence of processing steps. A typical sequence may include fetching the instruction from memory, decoding the instruction, accessing any operands that are required from a register bank, combining the operands to form the result or a memory address, accessing memory for a data operand if necessary, and writing the result back to the register bank. Modern computer processors execute numerous instructions to carry out the computing tasks. Different tasks may require different components to complete the function, and in order to improve the processor productivity, it is much more efficient to start the next instruction before the current one has finished. As such, different instructions are started sequentially and in different stages at any time during the processing thereof. This is known as a pipelined method for processing the instructions.

Furthermore, some of the instructions are conditional instructions whose executions depend on some required conditions to be fulfilled. Some of these conditional instructions require multiple clock cycles to complete the execution. Like any other instructions, the conditional instructions are also “pipelined” with other instructions to be processed.

It is not uncommon that many of the conditional instructions do not get executed because their prerequisite conditions may not be satisfied because other instructions may have altered the condition status of the processor with regard to such prerequisite conditions. Although the instruction will eventually be discarded, in the conventional art, the processor still executes quite a few steps such as decoding the instruction and accessing the register bank. As such, there is a significant amount of system resources wasted by the non-execution of these conditional instructions.

What is needed is an improved method and system for detecting as early as possible those conditional instructions whose conditions most likely will not be satisfied so that the system resources can be saved by not executing the instructions.

### SUMMARY

A method and system is disclosed for predicting whether a conditional instruction is to be executed in a processor. The processor processes instructions through clocked processing stages including at least a decode stage, an execute stage, and one or more intermediate processing stages therebetween. First, a current condition status of the processor is detected, wherein the condition status shows whether one or more conditions for executing the conditional instruction have been satisfied. After detecting whether one or more associated instructions being processed during the intermediate processing stages have impacted or will impact the conditions to be satisfied, it is determined whether the conditional instruction should be terminated at the decode stage based on the detected current condition status and the detected impact on the conditions due to the processing of the associated instructions. If it is predicted that the conditions for executing the conditional instruction in the execute stage cannot possibly be satisfied, the conditional instruction is terminated in the decode stage so as to avoid utilizing additional processor resources.

The present disclosure provides a method and system for optimizing the processing of conditional instructions, especially for multiple clock conditional instructions. It reduces the likelihood of having unnecessary data forwarding stalls caused by pipelined instructions. By terminating the conditional instructions early in the process, the throughput of the processor is increased, thereby enhancing the productivity of the processor.

### BRIEF DESCRIPTION OF THE DRAWINGS

FIG. 1 illustrates a flow diagram showing an instruction execution process.

FIG. 2 illustrates a flow diagram for processing a conditional instruction according to one example of the present disclosure.

FIG. 3 illustrates a flow diagram for predicting the execution of a conditional instruction according to the present disclosure.

### DESCRIPTION

The present disclosure provides an improved method for detecting as early as possible certain conditional instructions that will not be executed by a computer processor so as to save system resource and system power, thereby increasing the productivity of the computer system.

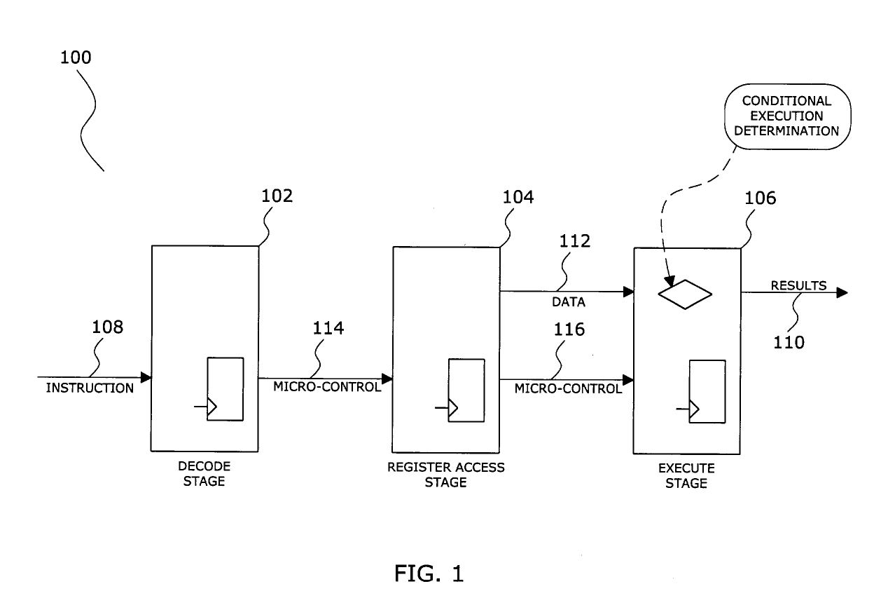

Computer processors are capable of conditionally executing instructions based on certain fulfilled conditions. FIG. 1 illustrates a general flow diagram 100 showing the execution of an instruction by a processor through three main processing stages. It is understood that after the instruction is fetched, the rest of the processing may generally be divided as three main stages, e.g., the decoding stage 102, register access stage 104, and execution stage 106. The instruction 108 is fed into the processor and goes through at least these three processing stages to produce an output result 110. Each stage may take one or more clock cycles. During the decode stage 102, an instruction decode section of a processor assumes that the instruction will be executed, and generates required microinstruction control signals (or “micro-controls”) 114. It may further determine how many clocks are required to execute the particular instruction based on the micro-controls generated. After the register access stage 104 produces required data 112 based on the instruction, the micro-controls 116 and the data both enter into the execute stage 106 to be processed. The execute stage 106 may determine whether the conditional instruction 108 should be appropriately executed or skipped based on some computations and comparisons using the received data 112 and micro-controls 116. In the conventional art, since all instructions will go through all three main stages regardless of whether a conditional instruction will be eventually executed or not in the execute stage, significant processor time and power resources are consumed for those conditional instructions that are actually abandoned or skipped at the end. This waste of system resource is especially large for operations that require multiple clock cycles.

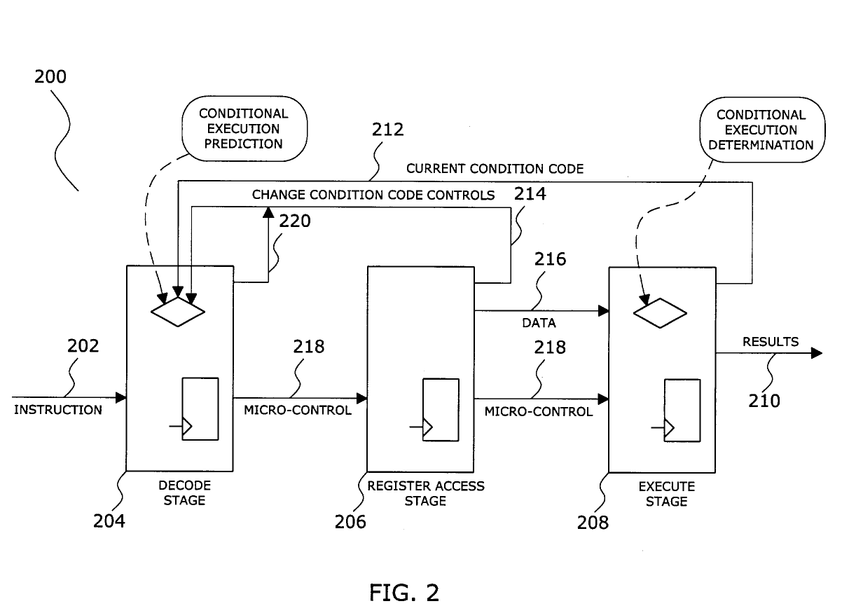

FIG. 2 illustrates another processing flow diagram 200 according to one example of the present disclosure wherein a conditional instruction is terminated early once it is clear that certain conditions for executing the instruction are not fulfilled. Similar to what is illustrated in FIG. 1, it is assumed that an instruction 202 comes into various processing stages, e.g., decode stage 204, register access stage 206, and execute stage 208. The instruction 202 is a conditional instruction whose execution requires that one or more conditions are to be fulfilled. After going through the processing stages, a result 210 is generated appropriately. It is noted that as not only one instruction is processed by the processor at any moment, several instructions may be “pipelined” sequentially as they progress through different stages of the processing. For the discussion in this disclosure, the entire processing flow can be referred to as a pipeline. It is most likely that there are other instructions in the pipeline that may affect the conditions required for the conditional instruction 202. As those interrelated or associated instructions go through the processing stages of their own, they may change the condition status of the processor with regard to the conditional instruction 202. If such associated instructions alter the conditions of the conditional instruction 202, they may eventually lead the processor to abandon the execution of the conditional instruction because the conditions are not fulfilled. The condition status of the processor with regard to the conditional instruction 202 reflects whether the conditions of the conditional instruction 202 have been changed by other associated instructions.

In order to execute conditional instructions in the most efficient way possible, a feedback mechanism is implemented. First, an indication or a status signal 212 is generated from the execute stage 208 indicating the current processor condition status with regard to the conditional instruction 202. This current condition code or current condition status signal 212 is fed back to the decode stage 204 so that the condition status of the processor with regard to the conditions required for executing the conditional instruction 202 is known at that time. A second monitoring/change signal referred to as a change condition code control 214 is also generated from intermediate processing stages such as the register access stage 206. Moreover, for any intermediate processing stages in which the conditions of the instruction 202 may be changed due to the processing of the associated instructions, the change condition control is generated therefrom and fed back to the decode stage to indicate that certain conditions are altered (e.g., not fulfilled). It is noted that more than one change condition code control can be generated if needed, and that the intermediate processing stages other than the register access stage 206 can be involved although the register access stage is used as a representation of all necessary intermediate processing stages between the decode stage 204 and the execute stage 208. Lastly, the decode stage 204 itself may also generate a change condition code control if necessary 220. With the current condition status signal 212, and the feedback change condition code controls 214 and 220, whether the conditional instruction 202 will be executed can sometimes be predicted within the decode stage.

Also illustrated in FIG. 2, as in FIG. 1, is a data line feeding data 216 as the processing progresses from the register access stage 206 to the execute stage 208. The micro-controls 218 generated in the decode stage 204 are propagated through all the stages. The micro-controls 218 may indicate whether the current condition status of the processor is allowed to change due to the processing of the associated instructions.

As a number of interrelated/associated instructions are pipelined through various processing stages, at any moment, the conditions for executing the particular conditional instruction 202 may change in any intermediate stage. It is thus useful to detect as early as possible that the conditional instruction will not be executed because at least one prerequisite condition will not be fulfilled. The processor uses the current condition status signal 212 and change condition code controls 214 and 220 to determine if it can predict whether the conditional instruction 202 will eventually be executed in the execute stage 208. As it immediately becomes clear that the associated instructions in any intermediate stage may potentially change the processor's condition status for the conditional instruction 202, the conditional instruction in the decode stage 204 may be converted into microinstructions 218 for a meaningless operation such as a single clock cycle no-operation instruction. The conversion to the no-operation instruction stops the conditional instruction 202 from further propagating through other processing stages and eliminates the need of utilizing additional processing resources.

It is noted that not all instructions in the pipeline are related to the conditional instruction 202. Only those that will have an impact on the conditions for executing the instruction 202 are considered associated instructions. Further, a threshold requirement for termination may be set to decide whether the conditional instruction 202 should be terminated in the decode stage 204. For example, for certain instructions, if one change condition code control feeding back from other stages indicates that a condition will not be fulfilled, it is enough to terminate the conditional instruction right away. For other instructions, it may require two or more change condition code controls to justify a termination of the current conditional instruction in the decode stage. In some other cases, it may be specified that only when a change condition code control from a particular stage is “turned on,” the conditional instruction will be converted to a no-operation instruction.

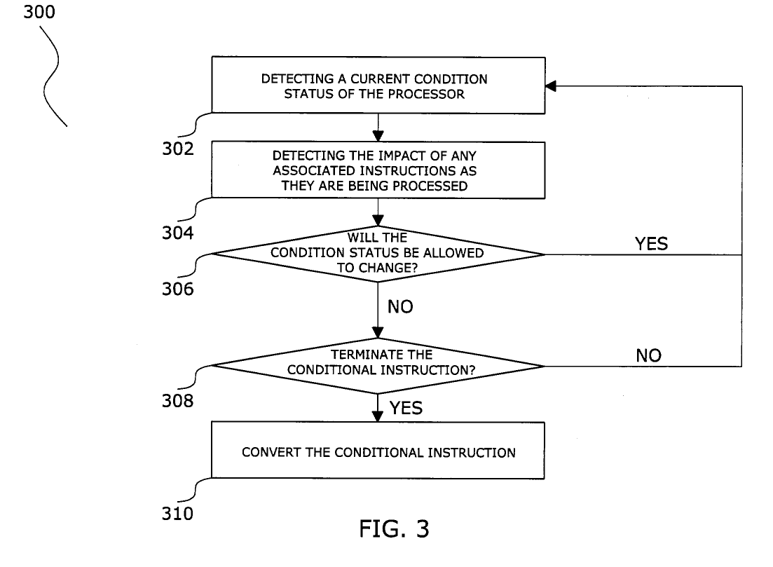

FIG. 3 is a flow diagram 300 illustrating how the execution of a conditional instruction is predicted according to the present disclosure. First, in step 302, a current condition status of the processor is detected. The current condition status indicates whether one or more conditions for executing the conditional instruction have been satisfied. Secondly, step 304 detects whether an associated instruction as being processed during an intermediate processing stage has impacted or will impact the conditions to be satisfied. In step 306, it is determined whether the current condition status of the processor is allowed to change based on the associated instruction being processed. If so, the impact of the associated instruction can determine whether the conditional instruction should be executed or skipped. If not, the processor can ignore the associated instruction and accurately predict whether the conditional instruction will be executed or skipped. In step 308, it is further determined whether the conditional instruction should be terminated at the decode stage based on the detected current condition status and the detected impact on the conditions due to the processing of the associated instruction. If a threshold termination requirement is met, then, the conditional instruction is terminated in step 310. Otherwise, the processor will keep monitoring the impact of other associated instructions.

The present disclosure provides a method and system for optimizing the processing of conditional instructions, especially for multiple clock conditional instructions. It reduces the likelihood of having unnecessary data forwarding stalls caused by pipelined instructions. By terminating the conditional instructions early in the process, the throughput of the processor is enhanced. As additional processing is avoided, the processor resource and power consumption is greatly reduced.

The above disclosure provides several different embodiments, or examples, for implementing different features of the disclosure. Also, specific examples of components, and processes are described to help clarify the disclosure. These are, of course, merely examples and are not intended to limit the disclosure from that described in the claims.

While the disclosure has been particularly shown and described with reference to the preferred embodiment thereof, it will be understood by those skilled in the art that various changes in form and detail may be made therein without departing from the spirit and scope of the disclosure.

What is claimed is:

1. A method for predicting whether a conditional instruction is to be executed in a processor, the processor processing instructions through at least a decode stage, an execute stage, and one or more intermediate processing stages therebetween, the method comprising:
generating a status signal indicating a current condition status of the processor, the condition status showing whether one or more conditions for executing the conditional instruction have been satisfied;
generating one or more change signals from the intermediate processing stages indicating whether one or more associated instructions as being processed therein change the condition status of the processor with regard to the conditional instruction; and
determining whether the conditional instruction should be terminated at the decode stage based on the status signal and one or more change signals,
wherein the status signal and change signals indicate whether there are unsatisfied conditions for executing the conditional instruction.

2. The method of claim 1 wherein the conditional instruction is a multi-clock instruction.

3. The method of claim 2 further comprising converting the conditional instruction to a one-clock meaningless operation if there is at least one unsatisfied condition.

4. The method of claim 1 further comprising eliminating the conditional instruction prior to the execution stage if it is to be discarded in the execution stage.

5. The method of claim 4 wherein the eliminating further includes converting the conditional instruction into a no-operation instruction.

6. The method of claim 1 further comprising generating a micro-control signal indicating whether the condition status of the processor is allowed to change during the processing of the associated instructions.

7. The method of claim 1 wherein the determining further includes setting a threshold requirement for terminating the conditional instruction in the decode stage based on the status signal and change signals.

8. A method for predicting whether a multiple-clock conditional instruction is to be executed in a processor, the processor processing instructions through clocked processing stages including at least a decode stage, an execute stage, and one or more intermediate processing stages therebetween, the method comprising:
detecting a current condition status of the processor, the condition status showing whether one or more conditions for executing the conditional instruction have been satisfied;
detecting whether one or more associated instructions as being processed during the intermediate processing stages have impacted or will impact the conditions to be satisfied;
determining whether the conditional instruction should be terminated at the decode stage based on the detected current condition status and the detected impact on the conditions due to the processing of the associated instructions; and
terminating the conditional instruction in the decode stage if it is predicted that there are unsatisfied conditions for executing the conditional instruction in the execute stage.

9. The method of claim 8 further comprising converting the conditional instruction to a meaningless operation if it is predicted that there will be one or more unsatisfied conditions.

10. The method of claim 9 wherein the converting further includes converting the conditional instruction into a no-operation instruction.

11. The method of claim 8 further comprising indicating whether the condition status of the processor is allowed to change during the processing of the associated instructions.

12. The method of claim 8 wherein the determining whether the conditional instruction should be terminated further includes setting a threshold requirement for terminating the conditional instruction in the decode stage.

13. A system for predicting whether a conditional instruction is to be executed in a processor, the processor processing instructions through at least a decode stage, an execute stage, and one or more intermediate processing stages therebetween, the system comprising:
means for generating a status signal indicating a current condition status of the processor, the condition status showing whether one or more conditions for executing the conditional instruction have been satisfied;
means for generating one or more change signals for the intermediate processing stages indicating whether one or more associated instructions as being processed therein change the condition status of the processor with regard to the conditional instruction; and
means for determining whether the conditional instruction should be terminated at the decode stage based on the status signal and one or more change signals,
wherein the status signal and change signals indicate whether there are unsatisfied conditions for executing the conditional instruction.

14. The system of claim 13 wherein the conditional instruction is a multi-clock instruction.

15. The system of claim 14 further comprising means for converting the conditional instruction to a one-clock operation if there are one or more unsatisfied conditions.

16. The system of claim 13 further comprising means for eliminating the conditional instruction prior to the execution stage if it is to be discarded in the execution stage.

17. The system of claim 16 wherein the means for eliminating further includes means for converting the conditional instruction into a meaningless instruction.

18. The system of claim 13 further comprising means for generating a micro-control signal indicating whether the condition status of the processor is allowed to change during the processing of the associated instructions.

19. The system of claim 13 wherein the means for determining further includes means for setting a threshold requirement for terminating the conditional instruction in the decode stage based on the status signal and change signals.
